(19) United States
(12) Patent Application Publication
(10) Pub. No.: US 2026/0365430 A1
(43) Pub. Date: Nov. 19, 2026

(54) PROCESSING APPARATUS, STORAGE SYSTEM, PROCESSING METHOD, AND NON-TRANSITORY COMPUTER-READABLE MEDIUM

(71) Applicant: TOYOTA JIDOSHA KABUSHIKI KAISHA, Aichi-ken (JP)

(72) Inventors: Kosuke HAKETA, Tokyo-to (JP); Sae KATAYAMA, Tokyo-to (JP); Yoshiaki TOYAMA, Tokyo-to (JP); Tatsuya TSUBAKIMOTO, Tokyo-to (JP); Huy DO XUAN, Tokyo-to (JP); Zoltan BECK, Tokyo-to (JP); Uori KOIKE, Saitama-shi (JP); Tetsuya IWASAKI, Inzai-shi (JP)

(73) Assignee: TOYOTA JIDOSHA KABUSHIKI KAISHA, Aichi-ken (JP)

(21) Appl. No.: 19/672,727

(22) Filed: May 11, 2026

(30) Foreign Application Priority Data
May 16, 2025 (JP) 2025-082747

(51) Int. Cl. B65G 1/137; G05D 1/667; G05D 105/28; G05D 107/17

(52) U.S. Cl. CPC B65G 1/1371; G05D 1/667; B65G 2203/0216; G05D 2105/285; G05D 2107/17

(57) ABSTRACT

A processing apparatus capable of bringing the inside of a post assigned to an individual dwelling of a housing complex into a desired state is provided. A processing apparatus is used to bring, by a robot capable of conveying an article between first posts assigned to respective individual dwellings of a housing complex and a second post shared by the individual dwellings of the housing complex, inside of the first post into a desired state, and includes: an information acquisition unit configured to acquire article information of the article and state request information of the inside of the first post; and a control unit configured to control the robot so that the inside of the first post satisfies a state request indicated by the state request information based on the article information and the state request information.

### CROSS REFERENCE TO RELATED APPLICATIONS

This application is based upon and claims the benefit of priority from Japanese patent application No. 2025-82747, filed on May 16, 2025, the disclosure of which is incorporated herein in its entirety by reference.

### BACKGROUND

The present disclosure relates to a processing apparatus, a storage system, a processing method, and a processing program. For example, the present disclosure relates to a processing apparatus, a storage system, a processing method, and a processing program which are used to bring, by a robot capable of conveying an article between first posts installed in a housing complex and assigned to respective individual dwellings of the housing complex and a second post installed in the housing complex and shared by the individual dwellings of the housing complex, the inside of the first post into a desired state.

For example, Patent Literature 1 discloses a storage system in which a user can determine whether or not to use, based on an internal image of a predetermined compartment in a storage apparatus which becomes a candidate for a deposit place (i.e., storage place) of user's article, the predetermined compartment as the deposit place of the user's article.

[Patent Literature 1] Japanese Unexamined Patent Application Publication No. 2023-28358

### SUMMARY

The applicant of the present disclosure has found the following problem. In the storage system disclosed in Patent Literature 1, it is impossible to bring the inside of the post assigned to an individual dwelling of the housing complex into a desired state.

The present disclosure has been made to solve such a problem, and provides a processing apparatus, a storage system, a processing method, and a processing program capable of bringing the inside of a post assigned to an individual dwelling of a housing complex into a desired state.

A processing apparatus according to an aspect of the present disclosure is a processing apparatus used to bring, by a first robot capable of conveying an article between first posts installed in a housing complex and assigned to respective individual dwellings of the housing complex and a second post installed in the housing complex and shared by the individual dwellings of the housing complex, inside of the first post into a desired state, including:
an information acquisition unit configured to acquire article information of the article and state request information of the inside of the first post; and
a control unit configured to control the first robot so that the inside of the first post satisfies a state request indicated by the state request information based on the article information and the state request information.

The above-described processing apparatus preferably further includes a selection unit configured to select which of the second post and a third post installed outside the housing complex the article should be stored in,
the information acquisition unit preferably acquires desired time limit information until the article retrieved from the second post or the third post is stored in the first post,
the selection unit preferably selects which of the second post and the third post the article should be stored in based on the desired time limit information,
when the second post is selected, the control unit preferably controls the first robot so as to store the article in the second post, and
when the third post is selected, the control unit preferably controls the first robot, and further controls a second robot or notifies a worker so that the article is stored in the third post through the second post, the second robot being capable of moving outside the housing complex and conveying the article between the second post and the third post.

In the above-described processing apparatus, a plurality of third posts are preferably arranged, and
the selection unit preferably selects the third post in such a manner that the longer the desired time limit information is, a third post further from the first post is selected.

The above-described processing apparatus preferably further includes:
a determination unit configured to determine a possibility of retrieval of the article based on article information including a name of the article or the state request information; and
a selection unit configured to select which of the second post and a third post installed outside the housing complex the article should be stored in based on the possibility of retrieval of the article,
when the second post is selected, the control unit preferably controls the first robot so as to store the article in the second post, and
when the third post is selected, the control unit preferably controls the first robot, and further controls a second robot or notifies a worker so that the article is stored in the third post through the second post, the second robot being capable of moving outside the housing complex and conveying the article between the second post and the third post.

In the above processing apparatus, the selection unit preferably selects the second post when the possibility of retrieval of the article is equal to or higher than a first threshold, and selects the third post when the possibility of retrieval of the article is lower than the first threshold.

In the above-described processing apparatus, a plurality of third posts are preferably arranged, and
the selection unit preferably selects the third post in such a manner that the lower the possibility of retrieval of the article is, a third post further from the first post is selected.

In the above-described processing apparatus, the determination unit preferably periodically determines the possibility of retrieval of the article, and
the selection unit preferably periodically selects the third post in such a manner that the higher the possibility of retrieval of the article is, a third post closer to the first post is selected.

In the above-described processing apparatus, the information acquisition unit preferably acquires information indicating a usage state of the first post, information indicating a usage state of the second post, and information indicating a usage state of the third post, and
the processing apparatus preferably includes a notification unit configured to notify a user of the first post of a management state of the article in the first post, a management state of the article in the second post, and a management state of the article in the third post based on the information indicating the usage state of the first post, the information indicating the usage state of the second post, and the information indicating the usage state of the third post.

A storage system according to an aspect of the present disclosure includes:
the above-described processing apparatus;
first posts installed in the housing complex and assigned to respective individual dwellings of the housing complex;
a second post installed in the housing complex and shared by the individual dwellings of the housing complex; and
a robot capable of conveying an article between the first post and the second post.

A processing method according to an aspect of the present disclosure is a processing method used to bring, by a robot capable of conveying an article between first posts installed in a housing complex and assigned to respective individual dwellings of the housing complex and a second post installed in the housing complex and shared by the individual dwellings of the housing complex, inside of the first post into a desired state, in which
a computer performs:
acquiring article information of the article and state request information of the inside of the first post; and
controlling the robot so that the inside of the first post satisfies a state request indicated by the state request information based on the article information and the state request information.

A processing program according to an aspect of the present disclosure is a processing program used to bring, by a robot capable of conveying an article between first posts installed in a housing complex and assigned to respective individual dwellings of the housing complex and a second post installed in the housing complex and shared by the individual dwellings of the housing complex, inside of the first post into a desired state, in which the processing program causes a computer to perform:
a process of acquiring article information of the article and state request information of the inside of the first post; and
a process of controlling the robot so that the inside of the first post satisfies a state request indicated by the state request information based on the article information and the state request information.

According to the present disclosure, it is possible to provide a processing apparatus, a storage system, a processing method, and a processing program capable of bringing the inside of a post assigned to an individual dwelling of a housing complex into a desired state.

The above and other objects, features and advantages of the present disclosure will become more fully understood from the detailed description given hereinbelow and the accompanying drawings.

### BRIEF DESCRIPTION OF DRAWINGS

FIG. 1 is a block diagram showing a configuration of a control system of a storage system according to a first embodiment;

FIG. 2 shows states when an article is conveyed in the storage system according to the first embodiment;

FIG. 3 is a perspective view roughly showing a configuration of a robot of the storage system according to the first embodiment;

FIG. 4 is a block diagram showing a configuration of the robot of the storage system according to the first embodiment;

FIG. 5 is a flowchart showing a flow of bringing the inside of a first post into a desired state by using the storage system according to the first embodiment;

FIG. 6 is a flowchart showing a flow of storing an article in another category in a second post by using a storage system according to a second embodiment;

FIG. 7 is a block diagram showing a configuration of a control system of a storage system according to a third embodiment;

FIG. 8 shows states when an article is conveyed in the storage system according to the third embodiment;

FIG. 9 is a perspective view schematically showing a configuration of a second robot of the storage system according to the third embodiment;

FIG. 10 is a block diagram showing a configuration of a robot of the storage system according to the third embodiment;

FIG. 11 is a flowchart showing a flow of storing an article which is not desired to be stored in a first post in a second post or a third post by using the storage system according to the third embodiment;

FIG. 12 is a flowchart showing a flow of storing an article which is not desired to be stored in the first post in the second post or the third post by using the storage system according to the third embodiment;

FIG. 13 is a flowchart showing a flow of storing a desired article in the first post by using the storage system according to the third embodiment;

FIG. 14 is a flowchart showing a flow of storing a desired article in the first post by using the storage system according to the third embodiment;

FIG. 15 is a block diagram showing a configuration of a control system of a storage system according to a fourth embodiment; and

FIG. 16 shows an example of a hardware configuration.

### DESCRIPTION OF EMBODIMENTS

A specific embodiment to which the present disclosure is applied will be described hereinafter in detail with reference to the drawings. However, the present disclosure is not limited to the below-shown embodiment. Further, the following description and drawings are simplified as appropriate.

### First Embodiment

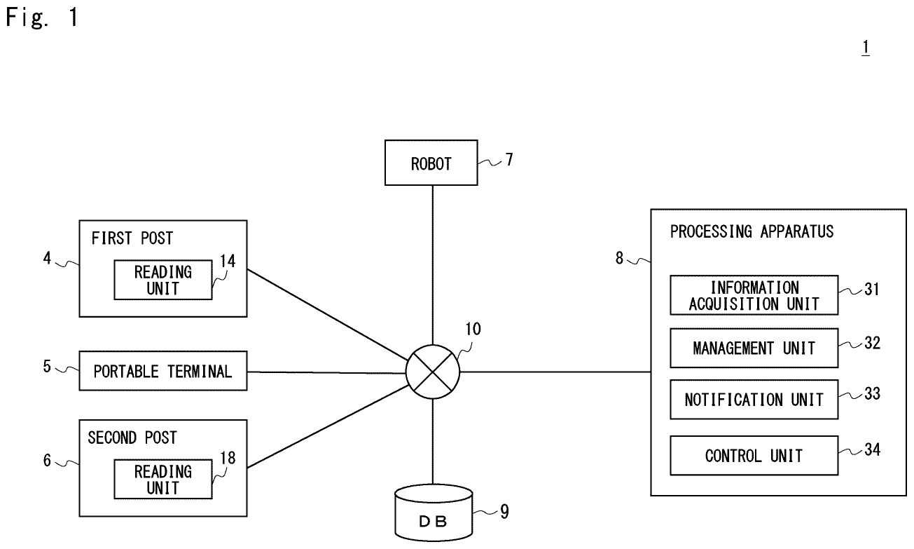

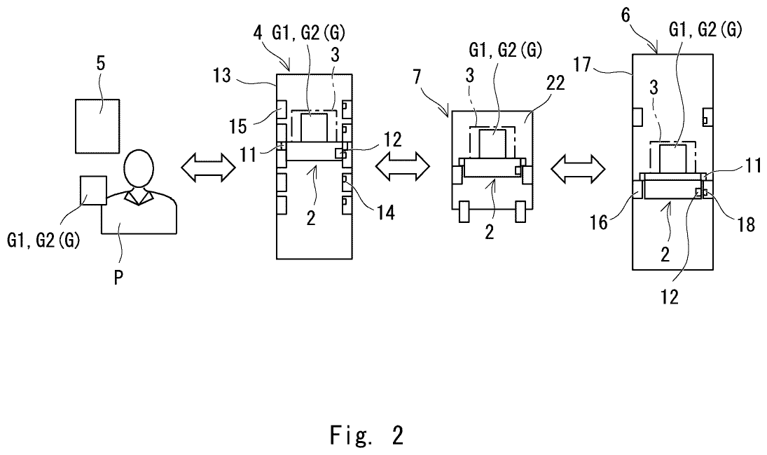

Firstly, a configuration of a storage system according to this embodiment will be described. FIG. 1 is a block diagram showing a configuration of a control system of a storage system according to this embodiment. FIG. 2 shows states when an article is conveyed in the storage system according to this embodiment.

A storage system 1 according to this embodiment is suitable, for example, for bringing the inside of a first post 4 into a desired state. As shown in FIGS. 1 and 2, the storage system 1 includes, for example, a tray 2, a storage box 3, a first post 4, a portable terminal 5, a second post 6, a robot 7, a processing apparatus 8, and a database (DB) 9.

The first post 4, the portable terminal 5, the second post 6, the first robot 7, the processing apparatus 8, and the DB 9 are connected to each other through a network 10. Note that the network 10 is preferably a wired or wireless communication line, for example, the Internet.

As shown in FIG. 2, the tray 2 has, for example, a plate-like shape as its basic shape on which an article G can be placed, and a brim 11 horizontally protrudes from the side of the tray 2. Further, for each tray 2, a tag 12 in which identification information assigned to that tray 2 is stored is provided on the side surface of the tray 2.

The tag 12 may be, for example, an NFC (Near Field Communication) tag from which the identification information can be read by a reading apparatus. The tray 2 is, for example, repeatedly used for conveying an article G and conveyed together with the article G.

The storage box 3 is, for example, a box that can be opened and closed as shown in FIG. 2, and is used for storing an article G to be conveyed. The storage box 3 is placed on the tray 2. Note that the identification information of the tray 2 may preferably include the identification information of the storage box 3 including information about the height of the storage box 3. Note that it is sufficient if the storage box 3 has a shape in which an article G can be stored, and may be, for example, formed integrally with the tray 2. A box owned by the owner P of an article G may be used as the storage box 3.

A first post 4 is assigned to each of the individual dwellings of the housing complex, and is preferably installed, for example, near the door of the individual dwelling. As shown in FIG. 2, the first post 4 is used to store the article G. The first post 4 includes, for example, a frame 13 and a reading unit 14.

The basic form of the frame 13 is, for example, a roughly rectangular shape when the frame 13 is viewed from the front. Note that, for example, the front of the frame 13 is preferably positioned on the side of the common corridor of the housing complex, and the rear of the frame 13 is positioned on the inside of the individual dwelling. On the inner-side surfaces of the frame 13, for example, a plurality of pairs of rails 15 are arranged at certain intervals in the up/down direction of the frame 13 as shown in FIG. 2.

The pair of rails 15 extends, for example, in the front/rear direction of the frame 13 as shown in FIG. 2, and supports the tray 2 as the brims 11 of the tray 2 are placed in the pair of rails 15. For each of the plurality of pairs of rails 15, identification information including information about the vertical position of the pair of rails 15 is attached to the pair of rails 15.

As shown in FIG. 2, for example, for each of the pairs of rails 15, a reading unit 14 is fixed to the frame 13. The reading unit 14 reads the identification information of the tray 2 from the tag 12 when the tray 2 is supported by (e.g., inserted in) the pair of rails 15.

The identification information of the first post 4 including the positional information of the first post 4 and the identification information of the rails 15 are attached to the reading unit 14. The reading unit 14 associates the read identification information of the tray 2 with the identification information of the first post 4 and the identification information of the rails 15 supporting the tray 2 in the first post 4, and transmits these identification information items to the DB 9. However, the internal structure of the first post 4 is not limited to the example shown in the drawing, and may be a closet in which articles are simply stored, a closet in which clothes are hung using hangers, or the like, i.e., may be any structure as long as the article G can be stored in a storage state designated by the owner P of the article G.

The portable terminal 5 is, for example, a portable terminal possessed by the owner P of the article G (i.e., the user of the first post 4), and is used to input state request information of the inside of the first post 4, article information, and the like, and to acquire request completion information from the processing apparatus 8.

The state request information of the inside of the first post 4 is instruction information for bringing the inside of the first post 4 into a desired state. For example, the state request information preferably includes information for instructing to store a desired article G or an article G in a desired category in the first post 4, information for instructing to prevent a desired article G or an article G in a desired category from being stored in the first post 4, or information indicating the position of an article G inside the first post 4. Further, the state request information may include deposit command information or retrieval command information for the article G.

The article information preferably includes, for example, information indicating the name of the article G, the category of the article G, and information indicating the name and address of the owner of the article G. The category of the article G is, for example, information indicating the attribute of the article G such as daily necessities, miscellaneous goods, books, and clothes.

The article information is preferably input, for example, through the portable terminal 5 when the owner P stores the article G in the storage box 3. The request completion information is information indicating that the state request of the inside of the first post 4 is satisfied.

The second post 6 is installed, for example, near the entrance of the housing complex as a common post for the individual dwellings (i.e., a post shared by the individual dwellings) of the housing complex. The second post 6 is used, for example, to store the article G so as to satisfy the state request of the inside of the first post 4. The structure of the second post 6 is roughly identical to that of the first post 4, but the second post 6 is preferably larger than the first post 4.

Therefore, as shown in FIG. 2, the second post 6 includes, for example, a frame 17 in which a plurality of pairs of rails 16 are arranged, and reading units 18 disposed in the frame 17 so as to be able to read the identification information of a tray 2 supported by the pair of rails 16 from the tag 12 of the tray 2.

Note that the front of the frame 17 may be positioned on the outside of the housing complex, and the rear of the frame 17 may be disposed on the inside the housing complex. Identification information of the second post 6 including positional information of the second post 6 and identification information of the rails 16 are attached to the reading unit 18.

The reading unit 18 associates the read identification information of the tray 2 with the identification information of the second post 6 and the identification information of the rails 16 supporting the tray 2 in the second post 6, and transmits these identification information items to the DB 9.

The robot 7 is a mobile body for arranging articles inside the first post 4, conveying an article G from the first post 4 to the second post 6, and conveying an article G from the second post 6 to the first post 4. That is, the robot 7 is disposed so as to be able to move inside the housing complex.

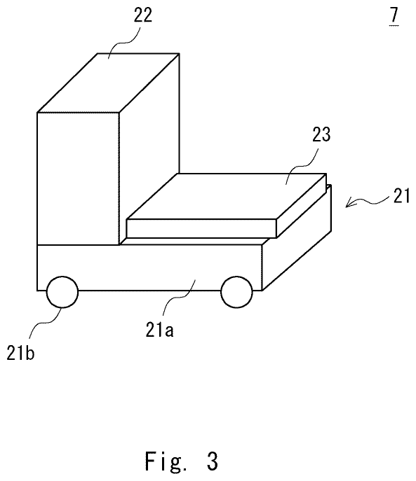

FIG. 3 is a perspective view schematically showing the structure of the robot of the storage system according to this embodiment. As shown in FIG. 3, the robot 7 includes, for example, a carriage part 21, a storage part 22 which is provided on the carriage part 21 and in which a tray 2 on which a storage box 3 is placed can be stored, and a mounting table 23 which is provided on the carriage part 21 and on which a tray 2 on which a storage box 3 is placed can be placed.

The mounting table 23 includes a mechanism for mounting a tray 2 retrieved from the storage part 22 thereon and storing this tray 2 in the first post 4 or the second post 6, or mounting a tray 2 retrieved from the first post 4 or the second post 6 thereon and storing this tray 2 in the storage part 22.

The mounting table 23 can be moved up and down along the vertical direction and includes an extendable arm (not shown) that can be expanded and contracted along the horizontal direction axis. The mounting table 23 may be configured to be rotatable about the vertical axis. Further, the mounting table 23 may be configured to be movable in all directions (360°) with a tray 2 placed thereon.

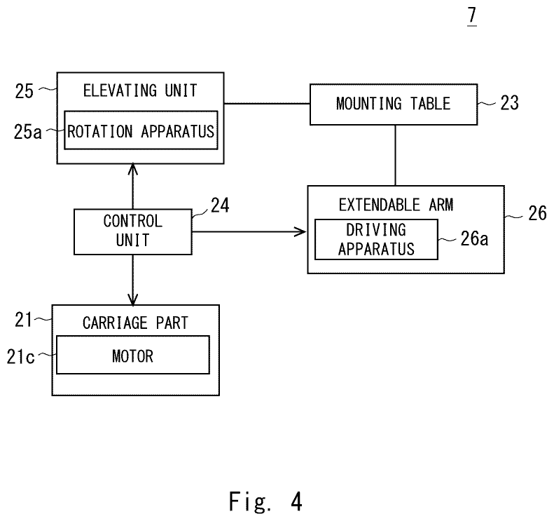

FIG. 4 is a block diagram showing the configuration of the robot of the storage system according to this embodiment. The robot 7 includes a control unit 24. The control unit 24 is preferably provided in the robot 7. The control unit 24 controls the carriage part 21, an elevating unit 25, and the extendable arm 26 based on control information received from the control unit 34 of the processing apparatus 8.

As shown in FIGS. 3 and 4, the carriage part 21 includes a base part 21a, wheels 21b rotatably provided on the base part 21a, and motors 21c for rotationally driving predetermined wheels 21b. Each motor 21c rotates and stops a predetermined wheel 21b based on a control signal received from the control unit 24. In this way, the robot 7 can move to and stop at an arbitrary position.

Note that the configuration of the carriage part 21 is merely an example and is not limited to the above example. For example, the number of wheels 21b of the carriage part 21 can be arbitrarily determined, and any configuration can be applied as long as the robot 7 can move to an arbitrary position.

The elevating unit 25 includes a rotation apparatus 25a, and expands or contracts along the vertical axis by the driving of the rotation apparatus 25a, and thereby moving up or down the mounting table 23. As the mounting table 23 is moved up or down, it is possible to hand over the tray 2 to or from a space at a different height of the first post 4 or the second post 6.

The extendable arm 26 is attached to the mounting table 23. The extendable arm 26 includes an arm main part (not shown) and a driving apparatus 26a. The driving apparatus 26a is attached inside the mounting table 23 and moves the arm main part in the horizontal direction. The driving apparatus 26a may further include a mechanism for rotating the arm main part about the axis.

After the elevating unit 25 moves up or down the mounting table 23 to the height of the empty space of the first post 4 or the second post 6, the extendable arm 26 slides the tray 2 along the rails 15 of the first post 4 or the rails 16 of the second post 6. In this way, the robot 7 can store the tray 2 on which the storage box 3 is placed in the empty space of the first post 4 or the second post 6.

After the elevating unit 25 moves up or down the mounting table 23 to the height of the storage space of the first post 4 or the second post 6, the extendable arm 26 slides and retrieves (i.e., takes out) the tray 2 from the storage space along the rails 15 of the first post 4 or the rails 16 of the second post 6. In this way, the robot 7 can retrieve (i.e., takes out) the tray 2 on which the storage box 3 is placed from the storage space of the first post 4 or the second post 6.

For example, as shown in FIG. 1, the processing apparatus 8 includes an information acquisition unit 31, a management unit 32, a notification unit 33, and a control unit 34. The information acquisition unit 31 acquires the identification information of the first post 4 with which the identification information of the tray 2 is associated and the identification information of the rails 15 supporting the tray 2 in the first post 4.

Further, the information acquisition unit 31 acquires the identification information of the second post 6 with which the identification information of the tray 2 is associated, the identification information of the rails 16 supporting the tray 2 in the second post 6, information indicating the usage state of the first post 4, information indicating the usage state of the second post 6, state request information, and article information.

The management unit 32 associates the article information with the identification information of the tray 2 based on the article information and the identification information of the tray 2. Further, the management unit 32 manages the usage state of the first post 4 based on the identification information of the first post 4 with which the identification information of the tray 2 is associated and the identification information of the rails 15 supporting the tray 2 in the first post 4, and generates information indicating the usage state of the first post 4.

Further, the management unit 32 manages the usage state of the second post 6 based on the identification information of the second post 6 with which the identification information of the tray 2 is associated and the identification information of the rails 16 supporting the tray 2 in the second post 6, and generates information indicating the usage state of the second post 6.

Therefore, the information indicating the usage state of the first post 4 and the information indicating the usage state of the second post 6 preferably include, for each post, identification information of used rails and vacant rails in the post, information about an article stored in the storage box 3, and the like. The information indicating the usage state of the first post 4 and the information indicating the usage state of the second post 6 are updated every time the tray 2 is inserted to or pulled out from the post.

The notification unit 33 transmits request completion information to the portable terminal 5 based on the information indicating the usage state of the first post 4. The control unit 34 controls the robot 7 based on the state request information, the information indicating the usage state of the first post 4, the information indicating the usage state of the second post 6, and the identification information of the tray 2 with which the article information is associated.

The DB 9 stores therein the identification information of the first post 4 with which the identification information of the tray 2 is associated, the identification information of the rails 15 supporting the tray 2 in the first post 4, the identification information of the second post 6 with which the identification information of the tray 2 is associated, the identification information of the rails 16 supporting the tray 2 in the second post 6, the information indicating the usage state of the first post 4, the information indicating the usage state of the second post 6, the state request information, the article information, the request completion information, and the like.

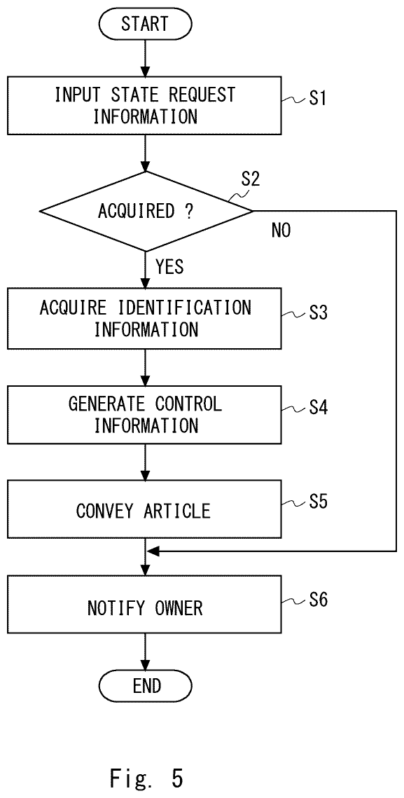

Next, a flow of bringing the inside of the first post 4 into a desired state by using the storage system 1 according to this embodiment will be described. FIG. 5 is a flowchart showing a flow of bringing the inside of the first post into a desired state by using the storage system according to this embodiment.

Firstly, in order to bring the inside of the first post 4 into a desired state, the owner P inputs state request information through the portable terminal 5 (S1). For example, the owner P inputs state request information so that an article G1 in a desired category (hereinafter, an article in a desired category may be assigned a symbol G1) is stored in the first post 4.

The portable terminal 5 transmits the state request information to the processing apparatus 8. The control unit 34 of the processing apparatus 8 searches for, for example, an article G1 based on the article information, the state request information, the information indicating the usage state of the first post 4, and the information indicating the usage state of the second post 6, and acquires identification information of the rails 15 of the first post 4 supporting the tray 2 on which the storage box 3 in which the article G1 is stored is placed and identification information of the first post 4.

In this process, the control unit 34 of the processing apparatus 8 determines whether identification information of the rails 16 of the second post 6 supporting the tray 2 on which the storage box 3 in which the article G1 is stored is placed and identification information of the second post 6 have also been acquired (S2).

When the identification information of the rails 16 of the second post 6 supporting the tray 2 on which the storage box 3 in which the article G1 is stored is placed has been acquired (Yes in S2), the control unit 34 of the processing apparatus 8 selects rails 15 in which the storage box 3 in which the article G1 is stored can be stored based on the information indicating the usage state of the first post 4 and the identification information of the tray 2 on which the storage box 3 in which the article G1 is stored is placed, and acquires identification information of the selected rails 15 and identification information of the first post 4 (S3).

Then, the control unit 34 of the processing apparatus 8 generates control information for conveying the storage box 3 in which the article G1 is stored from the second post 6 to the first post 4 based on the identification information of the rails 16 of the second post 6 supporting the tray 2 on which the storage box 3 in which the article G1 is stored is placed, the identification information of the second post 6, the identification information of the selected rails 15 in the first post 4, and the identification information of the first post 4 (S4).

Based on the control information, the robot 7 pulls out the tray 2 from the rails 16 of the second post 6 supporting the tray 2 on which the storage box 3 in which the article G1 is stored is placed, and stores the tray 2 in the storage part 22. The management unit 32 of the processing apparatus 8 updates the information indicating the usage state of the second post 6.

Then, based on the control information, the robot 7 conveys the tray 2 on which the storage box 3 in which the article G1 is stored is placed to the first post 4, retrieves the tray 2 from the storage part 22, inserts the tray 2 in the selected rails 15 in the first post 4, and thereby makes the rails 15 support the tray 2 (S5).

Next, when the management unit 32 of the processing apparatus 8 updates the information indicating the usage state of the first post 4, the notification unit 33 transmits request completion information to the portable terminal 5 of the owner P (S6). In this way, the owner P can recognize, through the portable terminal 5, that the inside of the first post 4 becomes a state that satisfies the desired state request.

On the other hand, when the identification information of the rails 16 of the second post 6 supporting the tray 2 on which the storage box 3 in which the article G1 is stored is placed has not been acquired (No in S2), it means that the article G1 has already been stored in the first post 4, so that the notification unit 33 of the processing apparatus 8 transmits request completion information to the portable terminal 5 of the owner P (S6), and the series of processes is finished.

As described above, the storage system 1 and the processing apparatus 8 according to this embodiment make (i.e., instruct) the robot 7 convey the article G so that the state request of the inside of the first post 4 is satisfied. Therefore, it is possible to bring the inside of the first post 4 assigned to the individual dwelling of the housing complex into the desired state.

Note that the control unit 34 of the processing apparatus 8 may control the robot 7 so that an article G in a desired category is disposed in a desired height range inside the first post 4. That is, in addition to bringing the inside of the first post 4 into a state where the article G1 is stored, the inside of the first post 4 may be put in order. The state request information may also be information for designating one or a plurality of articles to be stored in the first post 4. In this case, the control unit 34 of the processing apparatus 8 controls the robot 7 so that the one or plurality of designated articles are stored in the first post 4. That is, the desired state is a state in which the one or plurality of designated articles are stored in the first post 4. Further, the one or plurality of designated articles may include articles that are already stored in the first post 4. That is, the control unit 34 of the processing apparatus 8 controls the robot 7 so as to retrieve, the one or plurality of designated articles, an article(s) which is insufficient from the second post 6 and store them in the first post 4. The state request information may further include information for designating the layout of the one or plurality of designated articles in the first post 4. For example, the state request information designates, for each article, the position where the article should be disposed in the first post 4. The control unit 34 of the processing apparatus 8 controls the robot 7 so as to arrange the articles inside the first post 4 in an orderly manner based on the designated layout.

### Second Embodiment

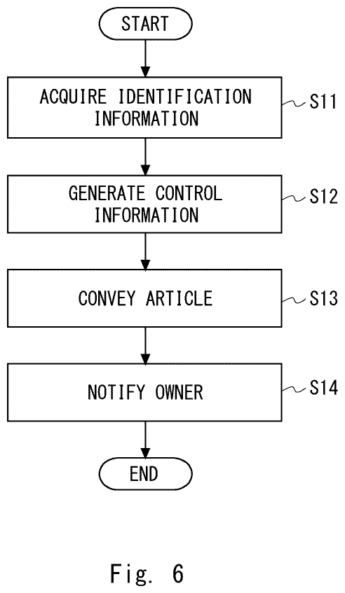

An article in another category G2 (hereinafter, an article in another category may be assigned a symbol G2) stored in the first post 4 may be stored in the second post 6. FIG. 6 is a flowchart showing a flow of storing an article in another category in the second post by using a storage system according to this embodiment.

Firstly, the control unit 34 of the processing apparatus 8 acquires identification information of the rails 15 supporting the tray 2 on which the storage box 3 in which an article G2 is stored is placed, stored in the first post 4 and identification information of the first post 4 based on the article information, the state request information, and the information indicating the usage state of the first post 4 (S11).

Then, the control unit 34 of the processing apparatus 8 selects rails 16 in which the storage box 3 can be stored in the second post 6 based on the information indicating the usage state of the second post 6 and the identification information of the tray 2 on which the storage box 3 in which the article G2 is stored is placed, and acquires identification information of the selected rails 16 and identification information of the second post 6.

Next, the control unit 34 of the processing apparatus 8 generates control information for conveying the storage box 3 in which the article G2 is stored from the first post 4 to the second post 6 based on the identification information of the rails 15 supporting the tray 2 on which the storage box 3 in which the article G2 is stored is placed in the first post 4 and the identification information of the first post 4, and the identification information of the selected rails 16 in the second post 6 and the identification information of the second post 6 (S12).

Based on the control information, the robot 7 pulls out the tray 2 on which the storage box 3 in which the article G2 is stored is placed from the rails 15 in the first post 4, and stores the tray 2 in the storage part 22. The management unit 32 of the processing apparatus 8 updates the information indicating the usage state of the first post 4.

Then, based on the control information, the robot 7 conveys the tray 2 on which the storage box 3 in which the article G2 is stored is placed to the second post 6, retrieves the tray 2 from the storage part 22, inserts the tray 2 into the selected rails 16 in the second post 6, and thereby makes the rails 16 support the tray 2 (S13).

The management unit 32 of the processing apparatus 8 updates the information indicating the usage state of the second post 6. In this way, it is possible to store only articles G1 in the first post 4. Further, the notification unit 33 of the processing apparatus 8 transmits request completion information to the portable terminal 5 of the owner P (S14).

### Third Embodiment

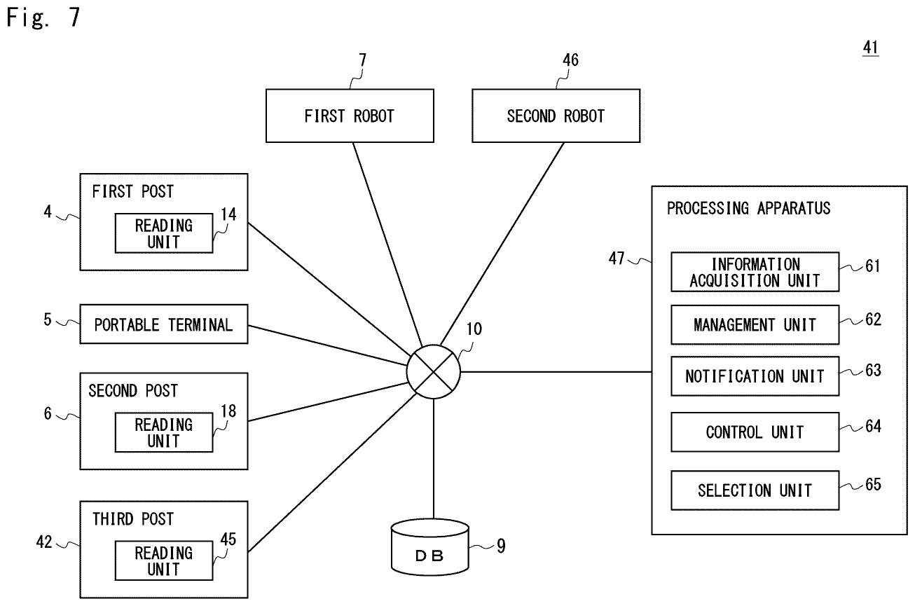

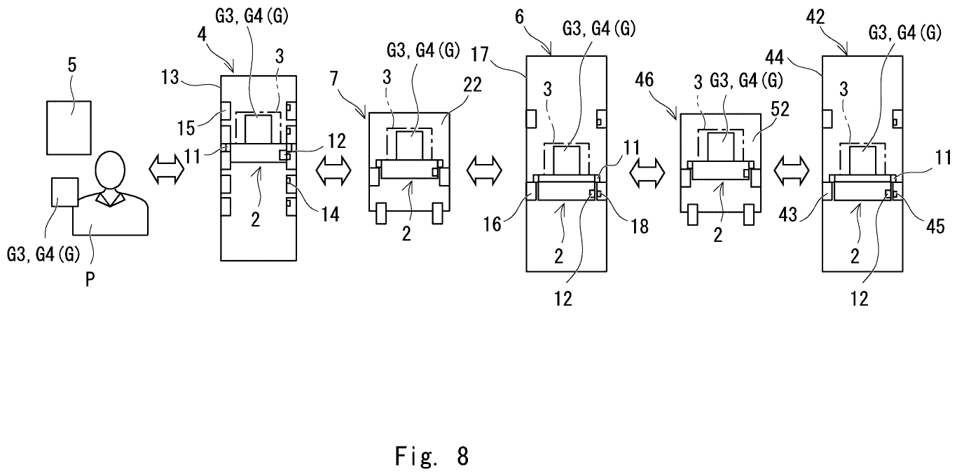

FIG. 7 is a block diagram showing a configuration of a control system of a storage system according to this embodiment. FIG. 8 shows states when an article is conveyed in the storage system according to this embodiment. Since the storage system 41 according to this embodiment has a configuration roughly identical to that of the storage system 1 according to the first embodiment, the detailed description thereof will be omitted.

The storage system 41 stores, based on desired time limit information of the article G, an article which is not desired to be stored in the first post 4, i.e., an article which is desired to be deposited in the shared post or the like, (hereinafter, an article which is not desired to be stored in the first post 4 may be assigned a symbol G3) in the second post 6 or a third post 42.

The owner P inputs desired time limit information of the article G through the portable terminal 5. The desired time limit information of the article G is information indicating a time limit from when the owner P inputs state request information to when the article G is stored in the first post 4, and, for example, can preferably be selected from within 30 minutes, within two hours, and the like through the portable terminal 5.

Regarding the third post 42, for example, a plurality of third posts 42 are preferably arranged over a wide area outside the housing complex in such a manner that the distances from the housing complex to the third posts 42 are different from one another. For example, as shown in FIGS. 7 and 8, the structure of the third post 42 is roughly identical to that of the second post 6. That is, the third post 42 includes a frame 44 in which a plurality of pairs of rails 43 are arranged, and reading units 45 disposed in the frame 44 so as to be able to read the identification information of a tray 2 supported by the pair of rails 43 from the tag 12 of the tray 2.

Identification information of the third post 42 including positional information of the third post 42 and identification information of the rails 43 are attached to the reading unit 45. The reading unit 45 associates the read identification information of the tray 2 with the identification information of the third post 42 and the identification information of the rails 43 supporting the tray 2 in the third post 42, and transmits these identification information items to the DB 9.

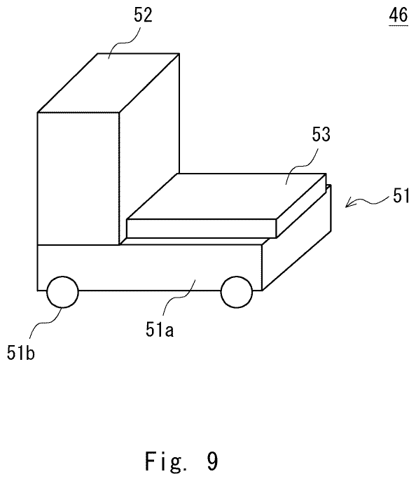

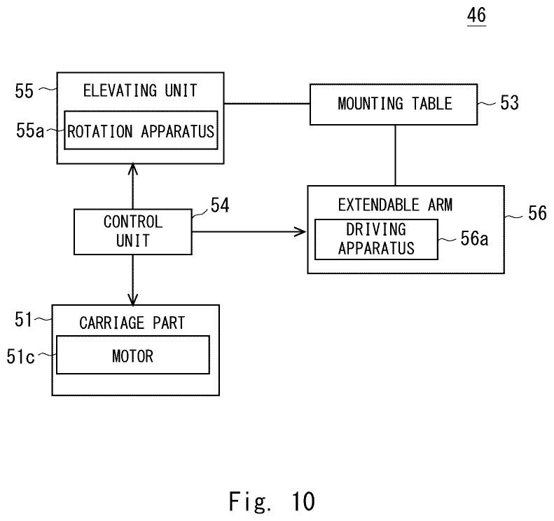

Note that, for example, an article G is preferably conveyed between the second post 6 and the third post 42 by using a second robot 46 outside the housing complex. The second robot 46 preferably has a configuration roughly identical to that of the robot (first robot) 7 in the first embodiment. FIG. 9 is a perspective view schematically showing the configuration of the second robot of the storage system according to this embodiment. FIG. 10 is a block diagram showing the configuration of the robot of the storage system according to this embodiment.

That is, as shown in FIGS. 9 and 10, the second robot 46 includes a base part 51a, wheels 51b, and a carriage part 51 including a motor(s) 51c, a storage part 52, a mounting table 53, and a control unit 54. Further, the mounting table 53 can be moved up and down by an elevating unit 55 including a rotation apparatus 55a. Further, an extendable arm 56 including an arm main part and a driving apparatus 56a is fixed to the mounting table 53.

As shown in FIG. 7, a processing apparatus 47 has a configuration roughly identical to that of the processing apparatus 8 in the first embodiment, and includes, in addition to an information acquisition unit 61, a management unit 62, a notification unit 63, and a control unit 64, a selection unit 65. The selection unit 65 selects which of the second post 6 or the third post 42 the article G should be stored in based on the desired time limit information of the article G.

The selection unit 65 determines, for example, whether or not the article G can be retrieved from the third post 42 and stored in the first post 4 through the second post 6 within the desired time limit of the article G based on the desired time limit information of the article G, the moving speed information of the first robot 7, the moving speed information of the second robot 46, the identification information of the first post 4, the identification information of the second post 6, and the identification information of the third post 42. Then, when it is possible, the selection unit 65 selects the third post 42 as the storage post of the article G3, whereas when it is impossible, the selection unit 65 selects the second post 6 as the storage post of the article G3.

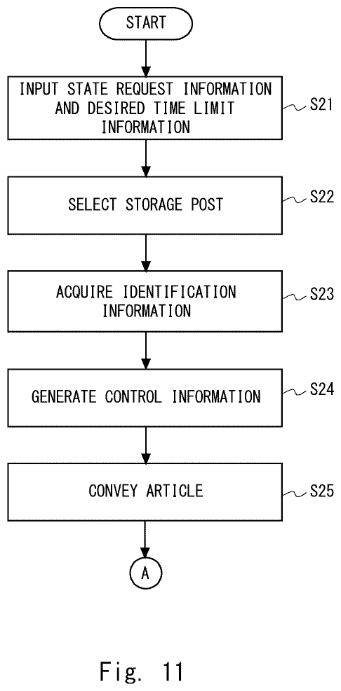

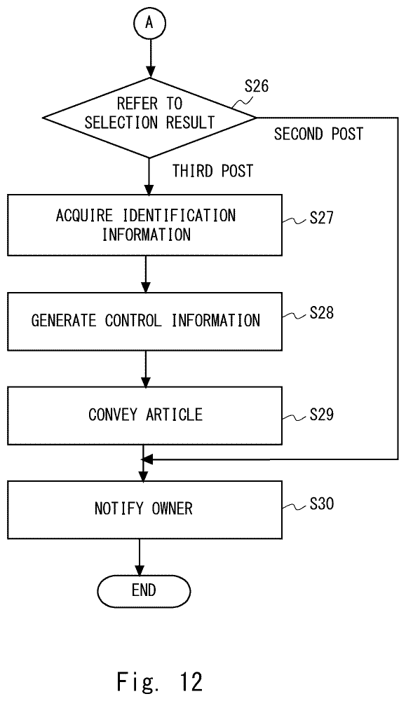

Next, a flow of storing an article G3 in the second post 6 or the third post 42 by using the storage system 41 according to this embodiment will be described. FIGS. 11 and 12 show a flowchart showing a flow of storing an article which is not desired to be stored in the first post in the second post or the third post by using the storage system according to this embodiment.

Firstly, in order to bring the inside of the first post 4 into a desired state, the owner P inputs state request information and desired time limit information of the article G through the portable terminal 5 (S21). For example, the owner P inputs state request information so that an article G3 is stored in the second post 6 or the third post 42. The portable terminal 5 transmits the state request information and the desired time limit information of the article G to the processing apparatus 47.

The selection unit 65 of the processing apparatus 47 determines whether or not the article G can be retrieved from the third post 42 and stored in the first post 4 through the second post 6 within the desired time limit of the article G based on the desired time limit information of the article G, the moving speed information of the first robot 7, the moving speed information of the second robot 46, the identification information of the first post 4, the identification information of the second post 6, and the identification information of the third post 42.

When it is possible, the selection unit 65 of the processing apparatus 47 selects the third post 42 as the storage post of the article G3 In this process, in the case where there are a plurality of third posts 42, the selection unit 65 preferably selects, among the third posts 42 from which the article G can be retrieved and stored in the first post 4 through the second post 6 within the desired time limit of the article G, a third post 42 farthest from the first post 4.

When it is impossible, the selection unit 65 of the processing apparatus 47 selects the second post 6 as the storage post of the article G3 (S22). Note that when the article G cannot be stored in the first post 4 within the desired time limit of the article G even when the second post 6 is selected as the storage post, the processing apparatus 47 preferably requests the owner P of the article G to re-enter the desired time limit information of the article G.

Next, in either case, i.e., in both of when the second post 6 is selected as the storage post and when the third post 42 is selected as the storage post, the processing apparatus 47 performs steps S23 to S25 equivalent to the steps S11 to S13 in the flow of storing the article G2 in the second post 6 by using the storage system according to the second embodiment.

Next, the control unit 64 of the processing apparatus 47 refers to the result of the selection by the selection unit 65 (S26). Then, when the third post 42 is selected as the storage post, the control unit 64 of the processing apparatus 47 specifies the rails 16 supporting the tray 2 on which the storage box 3 in which the article G3 is stored is placed based on the information indicating the usage state of the second post 6 and the identification information of the tray 2 on which the storage box 3 is placed, and acquires the identification information of the specified rails 16 and the identification information of the second post 6 (S27).

Then, the control unit 64 of the processing apparatus 47 selects rails 43 in which the storage box 3 can be stored in the third post 42 based on the information indicating the usage state of the third post 42 and the identification information of the tray 2 on which the storage box 3 in which the article G3 is stored is placed, and acquires the identification information of the selected rails 43 and the identification information of the third post 42.

The control unit 64 of the processing apparatus 47 generates control information for conveying the storage box 3 from the second post 6 to the third post 42 based on the identification information of the rails 16 supporting the tray 2 on which the storage box 3 in which the article G3 is stored is placed in the second post 6 and the identification information of the second post 6, and the identification information of the selected rails 43 in the third post 42 and the identification information of the third post 42 (S28).

Based on the control information, the second robot 46 pulls out the tray 2 from the rails 16 supporting the tray 2 on which the storage box 3 in which the article G3 is stored is placed in the second post 6, and stores the tray 2 in the storage part 52. The management unit 62 of the processing apparatus 47 updates the information indicating the usage state of the second post 6.

Then, based on the control information, the second robot 46 conveys the tray 2 on which the storage box 3 in which the article G3 is stored is placed to the third post 42, retrieves the tray 2 from the storage part 52, inserts the tray 2 into the selected rails 43 in the third post 42, and thereby makes the rails 43 support the tray 2 (S29).

The management unit 62 of the processing apparatus 47 updates the information indicating the usage state of the third post 42. In this way, the article G3 can be stored in the third post 42. Further, the notification unit 63 of the processing apparatus 47 transmits request completion information to the portable terminal 5 of the owner P (S30).

On the other hand, when the second post 6 is selected as the storage post, the notification unit 33 of the processing apparatus 8 transmits request completion information to the portable terminal 5 of the owner P (S30), and the series of processes is finished. In this way, the article G3 can be stored in the second post 6.

Note that the notification unit 63 of the processing apparatus 47 preferably notifies, based on the information indicating the usage state of the first post 4, the information indicating the usage state of the second post 6, and the information indicating the usage state of the third post 42, the owner P of information indicating, for each post, the management state of the article G in the post through the portable terminal 5.

The information indicating the management state of the article G preferably includes, for each post, information about the article stored in the storage box 3 supported on the rails of the post through the tray 2, identification information of the rails supporting the storage box 3, identification information of the post including the rails, and the like. In this way, the owner P can recognize which article is supported in which rails of which post.

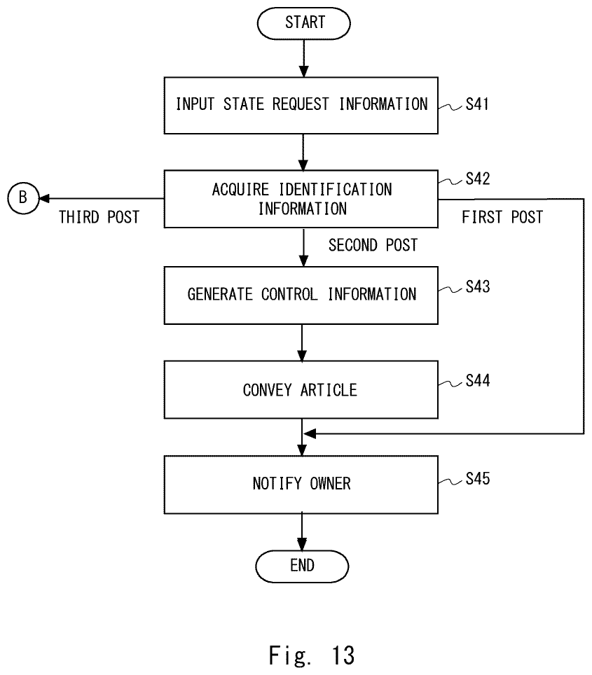

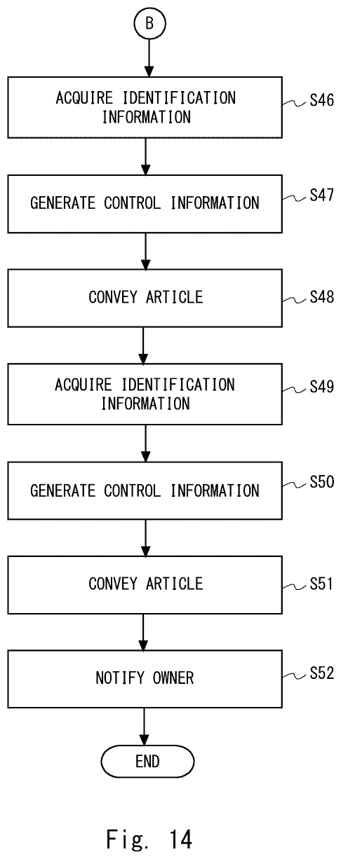

Next, a flow of storing a desired article G4 (hereinafter, a desired article may be assigned a symbol G4) in the first post 4 by using the storage system 41 according to this embodiment will be described. FIGS. 13 and 14 show a flowchart showing a flow of storing a desired article in the first post by using the storage system according to this embodiment.

Firstly, the owner P inputs state request information through the portable terminal 5 so that an article G4 is stored in the first post 4 (S41). The portable terminal 5 transmits the state request information to the processing apparatus 8.

The control unit 64 of the processing apparatus 47 searches for, for example, an article G4 based on the article information, the state request information, the information indicating the usage state of the first post 4, the information indicating the usage state of the second post 6, and the information indicating the usage state of the third post 42, and acquires identification information of the rails 15 of the first post 4 supporting the tray 2 on which the storage box 3 in which the article G4 is stored is placed and identification information of the first post 4, identification information of the rails 16 of the second post 6 and identification information of the second post 6, or identification information of the rails 43 of the third post 42 and identification information of the third post 42 (S42).

When the identification information of the rails 16 of the second post 6 supporting the tray 2 on which the storage box 3 in which the article G4 is stored is placed is acquired, the processing apparatus 47 performs steps of S43 to S45 equivalent to the steps S4 to S6 in the flow of bringing the inside of the first post 4 into a desired state by using the storage system 1 according to the first embodiment. In this way, the article G4 stored in the second post 6 can be stored in the first post 4. That is, the article G4 can be retrieved from the second post 6.

On the other hand, when the identification information of the rails 15 of the first post 4 supporting the tray 2 on which the storage box 3 in which the article G4 is stored is placed is acquired, it means that the article G4 has already been stored in the first post 4. Therefore, the notification unit 63 of the processing apparatus 47 transmits request completion information to the portable terminal 5 of the owner P (S45), and the series of processes is finished.

Further, when the identification information of the rails 43 of the third post 42 supporting the tray 2 on which the storage box 3 in which the article G4 is stored is placed is acquired, the control unit 64 of the processing apparatus 47 selects rails 16 in which the storage box 3 can be stored in the second post 6 based on the information indicating the usage state of the second post 6 and the identification information of the tray 2 on which the storage box 3 in which the article G4 is stored is placed, and acquires identification information of the selected rails 16 and identification information of the second post 6 (S46).

Then, the control unit 64 of the processing apparatus 47 generates control information for conveying the storage box 3 from the third post 42 to the second post 6 based on the identification information of the rails 43 supporting the tray 2 on which the storage box 3 in which the article G4 is stored is placed in the third post 42 and the identification information of the third post 42, and the identification information of the selected rails 16 in the second post 6 and the identification information of the second post 6 (S47).

Based on the control information, the second robot 46 pulls out the tray 2 on which the storage box 3 in which the article G4 is stored is placed from the rails 43 in the third post 42, and stores the tray 2 in the storage part 52. The management unit 62 of the processing apparatus 47 updates the information indicating the usage state of the third post 42.

Then, based on the control information, the second robot 46 conveys the tray 2 on which the storage box 3 in which the article G4 is stored is placed to the second post 6, retrieves the tray 2 from the storage part 52, inserts the tray 2 into the selected rails 16 in the second post 6, and thereby makes the rails 16 support the tray 2 (S48). The management unit 62 of the processing apparatus 47 updates the information indicating the usage state of the second post 6.

After that, the processing apparatus 47 performs steps S49 to S52 equivalent to the steps S3 to S6 in the flow of bringing the inside of the first post 4 into a desired state by using the storage system 1 according to the first embodiment. In this way, the article G4 stored in the third post 42 can be stored in the first post 4. That is, the article G4 can be retrieved from the third post 42.

As described above, for example, based on the desired time limit information of the article G set by the owner P, when the desired time limit is long, the storage system 41 and the processing apparatus 47 according to this embodiment can store the article G in the third post 42 which is installed at a place far from the housing complex and of which the land price is low. In this way, the storage space of the first post 4 can be put in order at a low cost.

### Fourth Embodiment

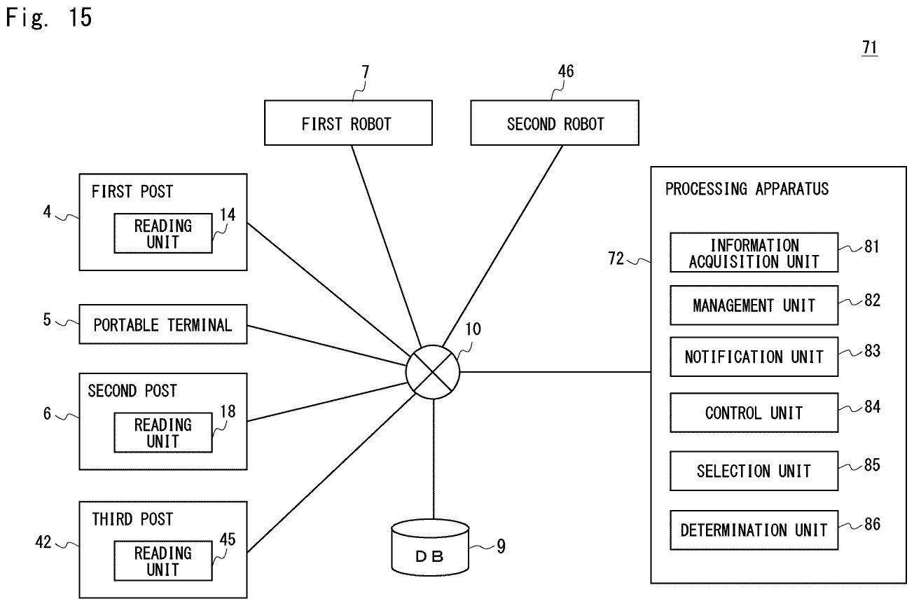

FIG. 15 is a block diagram showing a configuration of a control system of a storage system according to this embodiment. A storage system 71 according to this embodiment has a configuration roughly identical to that of the storage system 41 according to the second embodiment, and therefore, its detailed description is omitted. In this embodiment, an article G3 is stored in the second post 6 or the third post 42 based on the name of the article G3.

In particular, as shown in FIG. 15, a processing apparatus 72 according to this embodiment has a configuration roughly identical to that of the processing apparatus 47 according to the second embodiment, and includes, in addition to an information acquisition unit 81, a management unit 82, a notification unit 83, a control unit 84, and a selection unit 85, a determination unit 86.

The determination unit 86 determines, for example, whether or not an article G3 is a seasonal article based on the name of the article G3 contained in the article information of the article G3. Then, when the article G3 is a seasonal article, the determination unit 86 preferably sets the possibility of retrieval of the article G3 in such a manner that the more the season in which the article G3 is used approaches, the higher value the possibility of retrieval of the article G3 is set to.

In this process, the determination unit 86 preferably periodically determines the possibility of retrieval of the article G3. In this way, for example, the determination unit 86 determines the possibility of retrieval of the article G3 to be the lowest when the season in which the article G3 is used ends, and determines the possibility in such a manner that the more the aforementioned season approaches, the higher the possibility becomes.

The selection unit 85 selects which of the second post 6 and the third post 42 the article G3 should be stored in based on the possibility of retrieval of the article G3. For example, the selection unit 85 selects the second post 6 when the possibility of retrieval of the article G3 is equal to or higher than a first threshold, and selects the third post 42 when the possibility of retrieval of the article G3 is lower than the first threshold.

Further, the selection unit 85 preferably selects the post in such a manner that the higher the possibility of retrieval of the article G3 is, a post closer to the first post 4 is selected. That is, the article G3 is moved to a post closer to the first post 4 as the season approaches. In this way, when the season in which the article G3 is used approaches and state request information is received from the owner P, the article G3 can be swiftly delivered to the owner P.

For example, the selection unit 85 preferably selects the post in such a manner that the lower the possibility of retrieval of the article G3 is, a post further from the first post 4 is selected. In this way, the occupancy ratio of posts near the first post 4 can be reduced, and the storage space in the first post 4 can be smoothly adjusted (i.e., organized).

Note that in this embodiment, the selection unit 85 selects a post in which an article G3 is stored based on the name of the article G3. However, a season or the like in which the article G is likely to be used may be derived based on the relationship between the number of times the state request information of the article G is received from the owner P and the date and time, and the post in which an article G is stored may be selected based on the derived season or the like as described above.

### Other Embodiments

Although the present disclosure has been described as a hardware configuration in the above-described first to fourth embodiments, the present disclosure is not limited to the above-described hardware configuration. In the present disclosure, the process performed by each component may be carried out by having a CPU (Central Processing Unit) execute a computer program.

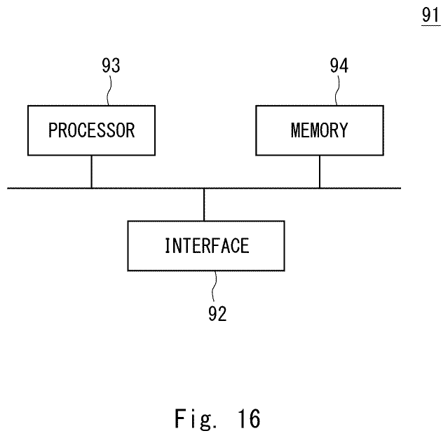

For example, each of the processing apparatuses 8, 47 and 72 according to the above-described embodiments may have a hardware configuration described below. FIG. 16 shows an example of a hardware configuration included in each of the processing apparatuses 8, 47 and 72.

The apparatus 91 shown in FIG. 16 includes an interface 92, a processor 93, and a memory 94. Each of the processing apparatuses 8, 47 and 72 described in the above-described embodiments is implemented by having the processor 93 load and execute a program stored in the memory 94. That is, this program is a program for causing the processor 93 to function as the each of the processing apparatuses 8, 47 and 72.

The above-described program includes instructions (or software codes) that, when loaded into a computer, cause the computer to perform one or more of the functions. The program may be stored in a non-transitory computer readable medium or a tangible storage medium. By way of example, and not a limitation, the non-transitory computer readable media or tangible storage media can include a RAM (Random-Access Memory), a ROM (Read-Only Memory), a flash memory, an SSD (Solid-State Drive) or other types of memory technologies, a CD-ROM, a DVD (Digital Versatile Disc), a Blu-ray (Registered Trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, the transitory computer readable media or communication media can include electrical, optical, acoustical, or other forms of propagation signals.

Although the present disclosure is described above with reference to example embodiments, the present disclosure is not limited to the above-described example embodiments. Various modifications that can be understood by those skilled in the art can be made to the configuration and details of the present disclosure within the scope and spirit of the disclosure. Further, the example embodiments may be combined with one another as appropriate.

For example, although the determination unit of the processing apparatus may select the second post 6 or the third post 42 as the storage post for the article G based on the possibility of retrieval of the article G, the determination unit may select a post far from the first post 4 as the storage post based on information about the height of the article G.

For example, the larger the height of the article G is, a post farther from the first post 4 is selected as the storage post. In this way, an article G having a large height can be stored in a post which is installed at a place far from the housing complex and of which the land price is low. In this way, the storage space of the first post 4 can be adjusted (i.e., organized) at a low cost.

For example, an article G stored in the second post 6 may be moved to a nearby third post 42, and by doing so, the storage space of the second post 6 may be temporarily increased.

For example, when a predetermined time period has elapsed in a state where an article G stored in the first post 4, the second post 6, or the third post 42, the management unit of the processing apparatus may inquire, through the notification unit, of the owner P about the disposal of the article G or so as to move the article G to a post far from the first post 4.

For example, the state request information of the article G may include reservation information for reserving the retrieval time of the article G, and/or reservation information for reserving the deposit time of the article G. Then, the processing apparatus may retrieve the article G or deposit (i.e., store in the shared post or the like) the article G based on these reservation information items.

For example, the information acquisition unit of the processing apparatus may acquire vacant individual dwelling information of the housing complex and use, when it deposits the article G in the second post 6, the post of the vacant individual dwelling as the second post 6.

For example, the first post 4 may be used as a delivery box. In this case, a predetermined area of the first post 4 may be used as a delivery box, and an article G may be stored in the other area of the first post 4. Further, the structure of the first post 4 is merely an example. That is, it is sufficient if at least an article G can be stored in the first post 4.

For example, the structures of the second post 6 and the third post 42 are also merely examples. That is, it is sufficient if at least an article G can be stored in each of them.

For example, although an article G is conveyed between the second post 6 and the third post 42 by the second robot 46 in the above-described embodiments, the article G may be conveyed by a worker. In this case, instruction information for conveying the article G may be transmitted to a portable terminal or the like processed by the worker.

For example, although an article G is conveyed by the tray 2 in the state where the article G is stored in the storage box 3 in the above-described embodiments, it is sufficient if at least the article G is conveyed.

For example, although the owner P inputs state request information and the like through the portable terminal 5 in the above-described embodiments, such information items may be input through an input device or the like disposed in the vicinity of the first post 4.

In short, the article G is preferably moved by the robot 7 so that the inside of the first post 4 becomes a state desired by the owner P.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A processing apparatus used to bring, by a first robot capable of conveying an article between first posts installed in a housing complex and assigned to respective individual dwellings of the housing complex and a second post installed in the housing complex and shared by the individual dwellings of the housing complex, inside of the first post into a desired state, comprising:
an information acquisition unit configured to acquire article information of the article and state request information of the inside of the first post; and
a control unit configured to control the first robot so that the inside of the first post satisfies a state request indicated by the state request information based on the article information and the state request information.

2. The processing apparatus according to claim 1, further comprising a selection unit configured to select which of the second post and a third post installed outside the housing complex the article should be stored in, wherein
the information acquisition unit acquires desired time limit information until the article retrieved from the second post or the third post is stored in the first post,
the selection unit selects which of the second post and the third post the article should be stored in based on the desired time limit information,
when the second post is selected, the control unit controls the first robot so as to store the article in the second post, and
when the third post is selected, the control unit controls the first robot, and further controls a second robot or notifies a worker so that the article is stored in the third post through the second post, the second robot being capable of moving outside the housing complex and conveying the article between the second post and the third post.

3. The processing apparatus according to claim 2, wherein
a plurality of third posts are arranged, and
the selection unit selects the third post in such a manner that the longer the desired time limit information is, a third post further from the first post is selected.

4. The processing apparatus according to claim 1, wherein
a determination unit configured to determine a possibility of retrieval of the article based on article information including a name of the article or the state request information; and
a selection unit configured to select which of the second post and a third post installed outside the housing complex the article should be stored in based on the possibility of retrieval of the article,
when the second post is selected, the control unit controls the first robot so as to store the article in the second post, and
when the third post is selected, the control unit controls the first robot, and further controls a second robot or notifies a worker so that the article is stored in the third post through the second post, the second robot being capable of moving outside the housing complex and conveying the article between the second post and the third post.

5. The processing apparatus according to claim 4, wherein the selection unit selects the second post when the possibility of retrieval of the article is equal to or higher than a first threshold, and selects the third post when the possibility of retrieval of the article is lower than the first threshold.

6. The processing apparatus according to claim 5, wherein
a plurality of third posts are arranged, and
the selection unit selects the third post in such a manner that the lower the possibility of retrieval of the article is, a third post further from the first post is selected.

7. The processing apparatus according to claim 6, wherein
the determination unit periodically determines the possibility of retrieval of the article, and
the selection unit periodically selects the third post in such a manner that the higher the possibility of retrieval of the article is, a third post closer to the first post is selected.

8. The processing apparatus according to claim 2, wherein
the information acquisition unit acquires information indicating a usage state of the first post, information indicating a usage state of the second post, and information indicating a usage state of the third post, and
the processing apparatus comprises a notification unit configured to notify a user of the first post of a management state of the article in the first post, a management state of the article in the second post, and a management state of the article in the third post based on the information indicating the usage state of the first post, the information indicating the usage state of the second post, and the information indicating the usage state of the third post.

9. A storage system comprising:
a processing apparatus according to claim 1;
first posts installed in the housing complex and assigned to respective individual dwellings of the housing complex;
a second post installed in the housing complex and shared by the individual dwellings of the housing complex; and
a robot capable of conveying an article between the first post and the second post.

10. A processing method used to bring, by a robot capable of conveying an article between first posts installed in a housing complex and assigned to respective individual dwellings of the housing complex and a second post installed in the housing complex and shared by the individual dwellings of the housing complex, inside of the first post into a desired state, wherein
a computer performs:
acquiring article information of the article and state request information of the inside of the first post; and
controlling the robot so that the inside of the first post satisfies a state request indicated by the state request information based on the article information and the state request information.

11. A non-transitory computer readable storage medium storing a processing program used to bring, by a robot capable of conveying an article between first posts installed in a housing complex and assigned to respective individual dwellings of the housing complex and a second post installed in the housing complex and shared by the individual dwellings of the housing complex, inside of the first post into a desired state, wherein the processing program causes a computer to perform:
a process of acquiring article information of the article and state request information of the inside of the first post; and
a process of controlling the robot so that the inside of the first post satisfies a state request indicated by the state request information based on the article information and the state request information.
